(19) United States
(12) Patent Application Publication
(10) Pub. No.: US 2019/0277380 A1
(43) Pub. Date: Sep. 12, 2019

(54) BALL SCREW DRIVE

(71) Applicant: Schaeffler Technologies AG & Co. KG, Herzogenaurach (DE)

(72) Inventors: Markus Oswald, Erlangen (DE); Dieter Adler, Schönwald (DE); Sigurd Wilhelm, Herzogenaurach (DE)

(73) Assignee: Schaeffler Technologies AG & Co. KG, Herzogenaurach (DE)

(21) Appl. No.: 16/334,782

(22) PCT Filed: Nov. 13, 2017
(86) PCT No.: PCT/DE2017/100956

§ 371 Date: Mar. 20, 2019

(30) Foreign Application Priority Data
Nov. 18, 2016 (DE) 102016222771.8

(51) Int. Cl. F16H 25/22; B60T 13/74; F16D 65/28

(52) U.S. Cl. CPC F16H 25/2204; B60T 13/745; F16D 2125/40; F16H 25/2214; F16D 65/28

(57) ABSTRACT

The threaded nut of a ball screw drive is adapted for applications that constrain the axial length such as brake boosters. The threaded nut includes an outer sealing surface suitable for sealing the threaded nut within a housing to form a pressurized chamber. The ball channels are at least partially axially overlapping with the outer sealing surface. Some embodiments may also include a ring groove on the outer periphery for receiving a sealing ring. Some embodiments may further include an inner sealing surface axially adjacent to the ball channels.

### CROSS-REFERENCE TO RELATED APPLICATIONS

This application is the U.S. National Phase of PCT Appln. No. PCT/DE2017/100956 filed Nov. 13, 2017, which claims priority to DE 102016222771.8 filed Nov. 18, 2016, the entire disclosures of which are incorporated by reference herein.

### TECHNICAL FIELD

The present disclosure concerns a ball screw drive.

### BACKGROUND

Ball screw drives convert a rotary motion into a translational motion. The disclosure also concerns electrohydraulic brakes and brake boosters in which such ball screw drives are used to generate a hydraulic pressure. Ball screw drives are preferably actuated by electric motors. Optionally, the threaded nut or threaded spindle may be rotationally driven.

DE102012217092 A1 discloses a brake booster which has a ball screw drive. The threaded nut of the ball screw drive is configured as a piston, the outer casing surface of which is formed as an outer cylindrical sealing face. The piston combined with the threaded nut is arranged so as to be longitudinally displaceable in a housing of a brake booster, and requires considerable axial installation space because of its combined construction. In modern motor vehicles, the installation space available is very limited.

### SUMMARY

The object of the disclosure is to specify a ball screw drive which can be configured compactly in the axial direction. This object is achieved by a ball screw drive which is provided with a threaded spindle and a threaded nut arranged thereon. Preferably, the threaded spindle is rotationally driven and axially stationary; in this case, the threaded nut is moved axially relative to the threaded spindle on a rotary motion of the threaded spindle.

Balls are arranged between the threaded spindle and the threaded nut in at least one ball channel which comprises ball grooves of the threaded nut and of the threaded spindle helically wound around the spindle axis.

An outer casing surface of the threaded nut is designed as an outer cylindrical sealing face. For example, a seal surrounding the threaded nut may rest against this sealing face. This seal may be configured as a sealing ring. This outer cylindrical sealing face is arranged axially at least overlapping the ball channel. Accordingly, viewed in the axial direction, the part of the threaded nut in which the ball channels are housed may be used as a piston. The ball channel is accordingly arranged partially or completely axially inside the axial extent of the cylindrical sealing face. If the overlap is complete, the cylindrical sealing face completely surrounds the ball channels in the axial direction. In any case, the cylindrical sealing face and the ball channel are arranged nested inside each other, so that a very compact construction is possible in the axial direction. The term “nested inside each other” accordingly means that the ball channel is arranged radially inside and axially partially or completely inside the cylindrical sealing face.

The threaded nut may be configured as a piston which is arranged so as to be longitudinally displaceable in a cylinder and together with the cylinder delimits a pressure chamber. The cylinder-side seal may lie sealingly on the cylindrical sealing face of the piston which also forms the threaded nut of the ball screw drive. In this way, the axial installation space of a brake booster for example may be substantially reduced.

The ball channel is preferably configured so as to be endless and has a load portion and a deflecting portion. The load portion is formed by the ball grooves helically wound around the spindle axis. The deflecting portion endlessly connects together a start and an end of the load portion. The deflecting portion in this case is arranged at least axially overlapping the cylindrical sealing face. These deflecting portions may be arranged on the nut side and in this case must surround the threaded shoulder of the ball groove provided on the spindle side. In this suitable refinement, the deflecting portion is arranged radially inside the outer casing surface of the threaded nut without penetrating this casing surface.

Said deflecting portion may have a deflecting piece which is arranged in a recess provided on the inner periphery of the threaded nut and formed inside the wall thickness of the threaded nut. To this end, a pocket may be formed on the inner periphery of the threaded nut which does not penetrate through the outer casing surface of the threaded nut. This ensures that the endless ball channel is housed radially fully inside the outer casing surface and can lie axially inside the cylindrical sealing face.

Suitably, several endless ball channels may be arranged along the spindle axis, the deflecting portions of which each connect a start and an end of the load portion of a common winding, wherein the deflecting pieces are distributed over the periphery and arranged axially successively in the pocket-like recesses.

The outer periphery of the threaded nut may be provided with at least one coaxially arranged ring groove for receiving a sealing ring, wherein the ring groove is arranged axially adjacent to the cylindrical sealing face. This configuration is suitable if the ball screw drive is for example part of an electrohydraulic brake booster. In this case, the threaded nut may be configured as a piston which is arranged so as to be longitudinally displaceable in a cylinder and together therewith delimits a hydraulic pressure chamber. In this case, the seal between the piston and cylinder is suitably designed such that the piston-side sealing ring lies sealingly on the wall of the cylinder, and a sealing ring arranged on the cylinder side may lie on the cylindrical sealing face of the piston.

In a suitable refinement, the inner periphery of the threaded nut may be provided with an inner cylindrical sealing face which is arranged axially adjacent to the ball channel. This refinement may also be suitable for the application described above when a further piston engages in the threaded nut or in the piston formed by the threaded nut, which further piston is arranged so as to be longitudinally displaceable relative to the threaded nut and lies sealingly on the inner cylindrical sealing face. This inner cylindrical sealing face may be arranged axially overlapping the ring groove described above on the outer periphery of the threaded nut.

Where the threaded nut is formed as a piston, preferably an integral component is used, the piston and threaded nut of which are produced from a single component and “in one casting”.

Ball screw drives are preferably used in brake boosters, wherein the threaded nut is configured as a piston which is arranged so as to be longitudinally displaceable in a cylinder, and wherein the threaded spindle is rotationally driven for axial displacement of the piston relative to the cylinder. Because the ball channels and the outer cylindrical sealing face overlap in the axial direction, an axially short construction of the brake booster can be achieved, which is highly advantageous in view of the very limited installation space in modern motor vehicles.

### BRIEF DESCRIPTION OF THE DRAWINGS

The brake booster and ball screw drive is described in more detail below with reference to two exemplary embodiments illustrated in a total of four figures.

FIG. 1 shows a longitudinal section through a ball screw drive in a first position,

FIG. 2 shows a longitudinal section through the ball screw drive from FIG. 1 in a second position,

FIG. 3 shows in perspective view and opened, a further exemplary embodiment of a ball screw drive, and

FIG. 4 shows diagrammatically, an extract of a braking system of a motor vehicle with brake booster.

### DETAILED DESCRIPTION

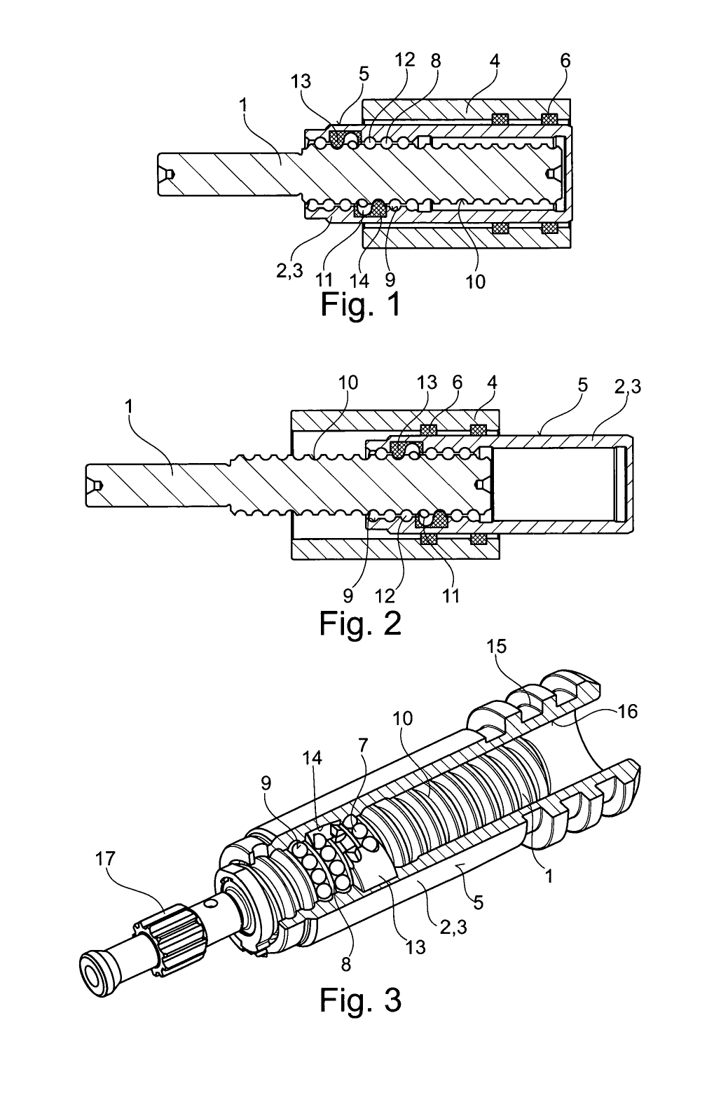

FIGS. 1 and 2 show a first exemplary embodiment of a ball screw drive, which comprises a rotationally driven, threaded spindle 1 and a threaded nut 2 arranged so as to be axially displaceable on the threaded spindle 1. FIG. 1 shows the ball screw drive with retracted threaded nut 2, and FIG. 2 with extended threaded nut 2.

The threaded nut 2 is formed as a piston 3 which engages in a cylinder 4, indicated diagrammatically. Instead of a cylinder, a housing may be provided. The outer casing surface of the threaded nut 2 is formed as a cylindrical sealing face 5 of the piston 3. A hydraulic pressure chamber (not shown) is delimited by the piston 3 and the cylinder 4. This pressure chamber adjoins the right-hand end of the cylinder 4. When the ball screw drive is actuated, i.e. the threaded spindle 1 is rotated, the piston 3 is moved axially relative to the cylinder 4 and hence the pressure chamber is enlarged or reduced.

Two axially adjacent sealing rings 6 are arranged on the inner periphery of the cylinder 4 and lie sealingly on the cylindrical sealing face 5 of the piston 3, and hence seal the pressure chamber hydraulically.

Balls 7 (FIG. 3) are arranged between the threaded spindle 1 and the threaded nut 2, and are arranged in several endless ball channels 8. Each ball channel 8 is formed by ball grooves 9, 10 of the threaded nut 2 and the threaded spindle 1 which are wound helically around the spindle axis, and by deflecting portions 11. The deflecting portions 11 each connect a start and an end of a load portion 12 of a common winding.

The deflecting portions 11 are each formed on a deflecting piece 13. These deflecting pieces 13 are distributed over the periphery and arranged axially successively in pocket-like recesses 14 of the threaded nut 2. The figures clearly show the arrangement of the pocket-like recesses 14 radially inside the casing surface of the threaded nut 2, i.e. inside the wall thickness of the threaded nut 2.

Accordingly, the pocket-like recesses 14 do not penetrate through the cylindrical sealing face 5 on the outer periphery of the threaded nut 2.

The figures clearly show that the cylindrical sealing face 5 and the ball channels 8 are arranged axially overlapping each other.

FIG. 3 shows a further exemplary embodiment which differs from the exemplary embodiment described above substantially in that the outer periphery of one axial end of the threaded nut 2 formed as a piston 3 is provided with two axially adjacent ring grooves 15 which are arranged coaxially to the spindle axis, for receiving sealing rings (not shown), wherein the ring grooves 15 are both arranged axially adjacent to the cylindrical sealing face 5.

A further difference from the first exemplary embodiment is that the threaded nut 2 is continuously open axially, and on its inner periphery is provided with an inner cylindrical sealing face 16 which is arranged axially adjacent to the ball channels 8. This inner cylindrical sealing face 16 is arranged axially overlapping the ring grooves 15. An inner piston (not shown) may be guided longitudinally displaceably on this inner cylindrical sealing face 16 and lie sealingly against this with its sealing rings.

FIG. 3 furthermore shows, on the left end of the threaded spindle 1, a pinion 17 provided with teeth which can be driven via a drive wheel (not shown). The threaded spindle 1 is rotationally driven by the pinion 17 which is fixedly connected to the threaded spindle 1.

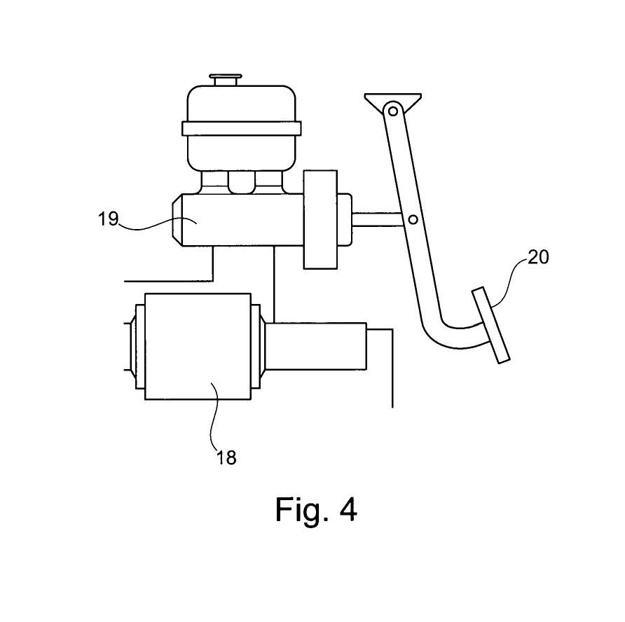

FIG. 4 shows diagrammatically an extract of a braking system of a motor vehicle. This extract depicts: a brake booster 18 with the ball screw drive as described above, a brake master cylinder 19 and a brake pedal 20. The cylinder 4 indicated in FIGS. 1 and 2 is part of the brake booster 18 and may be mounted on a housing of the brake booster 18.

### LIST OF REFERENCE SIGNS

1 Threaded spindle
2 Threaded nut
3 Piston
4 Cylinder
5 Cylindrical sealing face
6 Sealing ring
7 Ball
8 Ball channel
9 Ball groove
10 Ball groove
11 Deflecting portion
12 Load portion
13 Deflecting piece
14 Pocket-like recess
15 Ring groove
16 Inner cylindrical sealing face
17 Pinion
18 Brake booster
19 Brake master cylinder
20 Brake pedal

1. A ball screw drive, with a threaded spindle, a threaded nut arranged thereon and balls arranged between the threaded spindle and the threaded nut in at least one ball channel which comprises ball grooves of the threaded nut and of the threaded spindle helically wound around a spindle axis, wherein an outer casing surface of the threaded nut is configured as an outer cylindrical sealing face, wherein the outer cylindrical sealing face arranged axially at least overlapping the ball channel and wherein an inner periphery of the threaded nut is provided with an inner cylindrical sealing face which is arrange axially adjacent to the ball channel.

2. The ball screw drive of claim 1, wherein the ball channel is configured so as to be endless and has a load portion formed by the helically wound ball grooves and a deflecting portion endlessly connecting a start and an end of the load portion and arranged at least axially overlapping the outer cylindrical sealing face.

3. The ball screw drive of claim 2, wherein the deflecting portion is arranged radially inside the outer cylindrical sealing face.

4. The ball screw drive of claim 3, wherein a deflecting piece having the deflecting portion is arranged in a recess provided on the inner periphery of the threaded nut and formed inside a wall thickness of the threaded nut.

5. The ball screw drive of claim 4, with several endless ball channels arranged along the spindle axis, the deflecting portions of which each connect a start and an end of the load portion of a helical winding, wherein the deflecting portions are formed by several deflecting pieces distributed over the inner periphery and arranged axially successively in recesses.

6. The ball screw drive of claim 1, wherein an outer periphery of the threaded nut is provided with at least one coaxially arranged ring groove for receiving a sealing ring, wherein the ring groove is arranged axially adjacent to the outer cylindrical sealing face.

7. (canceled)

8. The ball screw drive of claim 6, wherein the inner cylindrical sealing face is arranged axially overlapping the ring groove.

9. The ball screw drive of claim 1, wherein the threaded nut is formed as a piston which is arranged so as to be longitudinally displaceable in a housing, wherein a cylinder-side seal lies sealingly on the outer cylindrical sealing face of the piston.

10. A brake booster with a ball screw drive as claimed in claim 1, wherein the threaded nut is formed as a piston which is arranged so as to be longitudinally displaceable in a cylinder, wherein the threaded spindle is rotationally driven to achieve an axial displacement of the piston relative to the cylinder.

11. A ball screw drive comprising:
a threaded nut having an inner periphery and an outer periphery, the inner periphery having helically wound ball grooves and an inner cylindrical sealing face, the outer periphery having an outer cylindrical sealing face overlapping the ball grooves; and
a deflecting piece arranged in a recess in the inner periphery of the threaded nut radially inward of the outer cylindrical sealing face.

12. The ball screw drive of claim 11, further comprising:
a threaded spindle extending into the threaded nut and having helically wound ball grooves that cooperate with the helically formed ball grooves of the threaded nut to form a ball channel, wherein the ball channel has a load portion and a deflecting portion formed by the deflecting piece endlessly connecting a start and an end of the load portion; and
a plurality of balls within the ball channel.

13. The ball screw drive of claim 11, wherein the outer periphery has at least one coaxially arranged ring groove for receiving a sealing ring, wherein the ring groove is arranged axially adjacent to the outer cylindrical sealing face.

14. The ball screw drive of claim 13, wherein the inner cylindrical sealing face is arranged axially overlapping the ring groove.

15. The ball screw drive of claim 11 further comprising a housing, wherein the threaded nut is formed as a piston which is arranged so as to be longitudinally displaceable within the housing, wherein a cylinder-side seal lies sealingly on the outer cylindrical sealing face.
